(19) United States
(12) Patent Application Publication
(10) Pub. No.: US 2026/0005252 A1
(43) Pub. Date: Jan. 1, 2026

(54) Lithium Battery

(71) Applicant: Petroliam Nasional Berhad (Petronas), Kuala Lumpur (MY)

(72) Inventors: Wei Siang SUM, Kuala Lumpur (MY); Geetha SRINIVASAN, Kuala Lumpur (MY); Muzdalifah Bt ZAKARIA, Kuala Lumpur (MY); Mark BISSETT, Manchester (GB); Ian KINLOCH, Manchester (GB); Lewis LE FEVRE, Manchester (GB)

(21) Appl. No.: 18/880,772

(22) PCT Filed: Jul. 4, 2023
(86) PCT No.: PCT/EP2023/068424

§ 371 Date: Jan. 3, 2025

(30) Foreign Application Priority Data
Jul. 4, 2022 (GB) 2209805.7

(51) Int. Cl. H01M 4/62; B60L 50/64; H01M 4/131; H01M 4/525; H01M 50/105

(52) U.S. Cl. CPC H01M 4/625; H01M 4/131; H01M 4/525; H01M 50/105; B60L 50/64; H01M 2220/20

(57) ABSTRACT

A solid-state battery, preferably a pouch cell, includes a cathode including cathode active material comprising Li ions, graphene, and optionally a binder; an electrolyte; and an anode, preferably a lithium anode, wherein said electrolyte is positioned in between said cathode and said anode.

### INTRODUCTION

The present invention relates to a solid-state battery, and in particular a pouch cell, comprising a cathode which comprises graphene as well as cathode active material and optionally binder. The invention also relates to a method of making a solid-state battery and to use of the solid-state battery in devices, such as electric vehicles and portable electronic devices. Further, the invention relates to a solid-state cathode composition comprising a cathode comprising cathode active material comprising Li ions, activated graphene, and optionally binder, as well as to methods of making such a composition, to cathodes comprising such a composition and to use of such a composition to make a solid-state cathode and/or solid-state battery, e.g. a pouch cell.

### BACKGROUND

There is a rapid transition towards battery powered vehicles, with lithium-ion batteries being the most promising technology. Traditional lithium-ion batteries have some inherent disadvantages including capacity fade during cycle-life (i.e. long term performance diminishes) and safety risks. In particular, the liquid electrolytes used in such batteries can lead to thermal runaways, electrolyte leaking and combustion.

These problems have led to the development of batteries with solid electrolytes. One of the main issues with solid-state lithium metal batteries is that they suffer from capacity fade over time, i.e. the battery capacity decreases during charge/discharge cycles, which reduces the lifetime of the battery. In solid-state batteries, the solid electrolyte/electrode interfaces play a key role in determining cycle lifetime. Consequently, current research has focussed on methods (e.g. spark plasma sintering, pressure activation of pouch cells) which improve the interphase interfacial resistance to enable cells to operate at higher capacities for a longer duration. Such methods strive to ensure adequate solid electrolyte/electrode contacts are achieved during the battery fabrication process. However, these methods are costly and time consuming.

Simultaneously, there has been a growing desire to provide lighter weight batteries suitable for, e.g. use in electric vehicles. This has fuelled research in the area of pouch cells, which achieve higher packing efficiency and lighter weight, than any other conventional battery type. Pouch cells also offer the advantage of providing flexibility of size and shape, and can, for instance, be readily provided in dimensions suitable for larger surface area applications, e.g. portable electronics. The increased dimensions of pouch cells, however, exacerbate the cost and time of complicated fabrication processes.

### SUMMARY OF INVENTION

Viewed from a first aspect, the present invention provides a solid-state battery, comprising:
(i) a cathode comprising cathode active material comprising Li ions, graphene, and optionally binder;
(ii) an electrolyte; and
(iii) an anode, preferably a lithium anode,
   wherein said electrolyte is positioned in between said cathode and said anode.

Preferably the solid-state battery is in the form of a pouch cell.

Viewed from a further aspect, the present invention provides a method of making a solid-state battery as hereinbefore described comprising:

(i) preparing a cathode comprising a cathode active material comprising Li ions, graphene and optionally binder;
(ii) preparing an electrolyte;
(iii) preparing an anode; and
(iv) laminating said cathode, electrolyte and anode to form said solid-state battery.

Viewed from a further aspect the present invention provides a method of making a pouch cell as claimed in any preceding claim, comprising:
(i) making a battery as hereinbefore defined; and
(ii) enclosing the battery in packaging defining a pouch.

Viewed from a further aspect, the present invention provides the use of a solid-state battery, preferably a pouch cell, as hereinbefore described in an electronic device, e.g. an electric vehicle or portable electronic equipment.

Viewed from a further aspect, the present invention provides a device, e.g. an electric vehicle, comprising a solid-state battery, preferably a pouch cell, as hereinbefore described.

Viewed from a further aspect, the present invention provides a solid-state cathode composition comprising:
(i) a cathode comprising cathode active material comprising Li ions;
(ii) activated graphene; and
(iii) optionally binder

Viewed from a further aspect, the present invention provides a method of making a solid-state cathode composition as hereinbefore described comprising: mixing cathode active material comprising Li ions; activated graphene; and optionally binder.

Viewed from a further aspect, the present invention provides a solid-state cathode comprising a composition as hereinbefore defined.

Viewed from a further aspect, the present invention provides a method of making a solid-state cathode as hereinbefore defined comprising depositing a slurry of a solid-state cathode composition on a cathode current collector, and drying to form said cathode.

Viewed from a further aspect, the present invention provides use of a composition as hereinbefore defined to make a solid-state cathode or a solid-state battery.

### DEFINITIONS

As used herein, the term “solid-state battery” refers to a battery comprising solid electrodes and a solid electrolyte. The presence of the solid electrolyte differentiates it from conventional batteries which tend to have liquid or polymer gel electrolytes.

As used herein, the term “secondary battery” refers to a battery which can be recharged by passing electric current through it, meaning it can be reused. The term “secondary battery” is sometimes used interchangeably with rechargeable battery.

As used herein, the term “pouch cell” refers to a battery contained in a non-rigid pouch, e.g. a non-rigid metal foil pouch.

### DETAILED DESCRIPTION OF THE INVENTION

The present invention relates to a solid-state battery comprising:
(i) a cathode comprising cathode active material comprising Li ions, graphene, and optionally binder;
(ii) an electrolyte; and
(iii) an anode, preferably a lithium anode,
   wherein said electrolyte is positioned in between said cathode and said anode.

Preferably the solid-state battery is a secondary battery.

Preferably the solid-state battery is in the form of a pouch cell.

Still more preferably the solid-state battery is a secondary battery in the form of a pouch cell.

The solid-state battery of the present invention advantageously achieves high capacity cycle stability, over a long period of time (e.g. >100 cycles). Thus the solid-state battery of the present invention retains at least 60% of its original capacity after ˜150 cycles, and in some cases at least 80% of its original capacity after ˜150 cycles. In contrast, conventional solid-state batteries maintain only 30% capacity after ˜40 cycles.

The solid-state battery of the present invention comprises a cathode comprising a cathode active material comprising Li ions, optionally a binder and graphene. The graphene may be powdered graphene or may be activated graphene. The presence of the graphene in the cathode of the solid-state battery of the invention significantly improves its high capacity cycle stability meaning the battery can be reused many more times than conventional secondary solid-state batteries.

Advantageously the graphene may be added to conventional cathode active materials comprising Li ions and optionally binder to prepare the cathode of the solid-state battery. This facilitates the preparation of pouch cells, including pouch cells of relatively large dimensions, with the solid-state battery of the present invention. This is beneficial as it avoids the need for costly and time-consuming processes such as spark plasma sintering and pressure activation, which are commonly required during pouch cell manufacture.

### Cathode

The cathode present in the solid-state battery of the present invention preferably comprises a cathode current collector. Any material conventionally used for this purpose may be employed. For example, the cathode current collector may be a sheet, foil, foam or mesh comprising a conductive metal, e.g. aluminium (Al), copper (Cu), titanium (Ti), germanium (Ge), stainless steel or mixtures thereof. Optionally the cathode current collector may comprise a carbon coating, preferably on the entirety of its surface. When a cathode current collector is present, the cathode active material comprising Li ions, graphene and optionally binder are preferably present as a layer on the cathode current collector. Optionally the cathode does not comprise a cathode current collector.

The cathode present in the solid-state battery of the present invention comprises a cathode active material comprising Li ions, graphene, and optionally binder. Preferably the cathode comprises a binder.

The cathode active material comprising Li ions may be any cathode active material capable of intercalation and de-intercalation of lithium ions. A significant number of such materials are known in the art and are available commercially. Preferred cathode active materials include lithium cobalt oxide, lithium nickel oxide, lithium iron phosphate, lithium manganese oxide, lithium copper oxide, lithium vanadium oxide, lithium nickel composite oxide, lithium nickel cobalt aluminium oxide, lithium nickel manganese oxide, lithium manganese composite oxide and Ni—Co—Mn ternary lithium metal oxide. Any known stoichiometries may be employed.

Representative examples of suitable cathode active materials include lithium cobalt oxide (LiCoO₂, LCO), lithium nickel oxide (LiNiO₂, LiNi₂O₄), lithium iron phosphate (LiFePO₄), lithium manganese oxide (Li₁₊ₓMn₂₋ₓO₄, wherein x is 0-0.33, e.g. LiMnO₃, LiMn₂O₃), lithium copper oxide (Li₂CuO₂), lithium vanadium oxide (LiV₃O₈), lithium nickel composite oxide (LiNi₁₋ₓMₓO₂, where M is Co, Al, Cu, Fe, Mg, B, or Ge, and x is 0.01-0.3), lithium nickel manganese oxide (LiNi₁₋ₓMnₓO₄ wherein x>0.5, e.g. LiNi_{0.5}Mn_{1.5}O₄), lithium nickel cobalt aluminium oxide (LiNiₓCo_{y}Al₂O₂, wherein 0<x<1, 0<y<1 and 0<z<1, NCA), lithium manganese composite oxide (LiMn₂₋ₓMₓO₂ where M is Co, Ni, Fe, Cr, Zn or Ta and x is 0.01-0.1, or LiMn₃MO₈ where M is Fe, Co, Ni, Cu or Zn), LiMn₂O₄ (LMO), Ni—Co—Mn ternary lithium metal oxide (Li[NiₓCO₁₋₂ₓMnₓO] wherein x is >0 and <0.5, NMC) and mixtures thereof.

Preferably the cathode active material comprising Li ions is selected from lithium cobalt oxide (LiCoO₂, LCO), LiMn₂O₄ (LMO), lithium nickel cobalt aluminium oxide (LiNiₓCo_{y}Al₂O₂, wherein 0<x<1, 0<y<1 and 0<z<1, NCA), lithium iron phosphate (LiFePO₄), and Ni—Co—Mn ternary lithium metal oxide (Li[NiₓCo₁₋₂ₓMnₓO]₂ wherein x is >0 and <0.5, NMC). Still more preferably the cathode active material comprising Li ions is selected from lithium nickel cobalt aluminium oxide (LiNiₓCo_{y}Al₂O₂, wherein 0<x<1, 0<y<1 and 0<z<1, NCA, e.g. LiNi_{0.80}Co_{0.15}Al_{0.05}O₂ (NCA8155)), and Ni—Co—Mn ternary lithium metal oxide (Li[NiₓCo₁₋₂xMnₓO] wherein x is >0 and <0.5, NMC). Yet more preferably the cathode active material comprising Li ions is a Ni—Co—Mn ternary lithium metal oxide of formula Li[NiₓCo₁₋₂ₓMnₓO]₂ and <0.5 (NMC). Examples include LiNi_{0.33}Co_{0.33}Mn_{0.33}O₂ (NCM333), LiNi_{0.50}Co_{0.20}Mn_{0.30}O₂ (NCM523), LiNi_{0.60}Co_{0.20}Mn_{0.2}O₂ (NCM622), and LiNi_{0.80}Co_{0.10}Mn_{0.10}O₂ (NCM811). A particularly preferred cathode active material comprising Li ions is Li[Ni_{0.6}Co_{0.2}Mn_{0.2}O]₂ (NMC622).

The cathode active material may be in any form. The cathode active material is preferably in the form of particles, and still more preferably in the form of spherical particles. The average particle diameter of the cathode active material is preferably 1 nm to 100 microns, preferably 10 nm to 75 microns, more preferably 150 nm to 50 microns. For examples the average particle diameter of the cathode active material may be <500 nm, e.g. 50 to 450 nm or 5 to 50 microns, e.g. 5 to 20 microns. The advantages of the present invention are, however, most pronounced when the cathode active material has a relatively large average particle diameter, such as 5 to 50 microns.

The cathode present in the solid-state battery of the present invention preferably comprises 50-99 wt %, more preferably 65-90 wt % and still more preferably 70-90 wt % cathode active material, based on the total weight of the cathode.

The cathode present in the solid-state battery of the present invention comprises graphene. Preferably the graphene is in the form of platelets, and more preferably nanoplatelets. Preferably the platelets have an average particle size of 1 to 5 microns. As supplied, the graphene tends to comprise agglomerates which may be broken down during processing, e.g. by shear.

In preferred cathodes of the solid-state battery of the present invention the graphene is activated graphene. The activation step preferably improves the flake-like morphology of the graphene and/or decreases the thickness of the graphene plates or flakes. Preferably the average particle size of activated graphene is 0.1-2 microns, and more preferably 0.1 to 1 micron. Preferably the average thickness of activated graphene is 1 to 9 nm, and more preferably 2 to 4 nm. Preferably the activation step results in thinner flakes, with reduced agglomeration.

Preferably the activated graphene has a specific surface area of 300 to 3000 m²/g, more preferably 500 to 800 m²/g and still more preferably 550 to 700 m²/g.

Preferably the activation step increases the porosity of the graphene.

Preferably the activated graphene is prepared by:
(a) contacting graphene with an alkaline solution to obtain alkali-treated graphene; and
(b) heating said alkali-treated graphene in an inert atmosphere to obtain activated graphene.

Suitable alkaline solutions include KOH, NaOH, KHCO₃, K₂C₂O₄, melamine and mixtures thereof. Preferably the alkaline solution is an aqueous hydroxide, and still more preferably KOH.

Preferably heating is carried out a temperature of 600 to 1200° C., more preferably 700 to 1000° C. and still more preferably 800 to 950° C. Preferably heating is carried out for 0.25 to 5 hrs, more preferably 0.5 to 2.5 hrs and still more preferably 0.75 to 2 hrs. Preferably heating is carried out at ambient pressure. Preferably heating is carried out in an argon atmosphere.

In a preferred process for preparing activated graphene the alkali-treated graphene is dried (e.g. in a furnace at 50-100° C.) and ground prior to heating in step (b). Grinding may, for example, be carried out using a mortar and pestle.

In a still further preferred process the activated graphene obtained in step (b) is washed with water, preferably deionised water, and dried (e.g. in a furnace at 50-100° C.). Optionally the washed activated graphene is then heated. Preferably heating is carried out a temperature of 600 to 1200° C., more preferably 700 to 1000° C. and still more preferably 800 to 950° C. Preferably heating is carried out for 0.25 to 5 hrs, more preferably 0.5 to 2.5 hrs and still more preferably 0.75 to 2 hrs. Preferably heating is carried out at ambient pressure. Preferably heating is carried out in an argon atmosphere.

Thus a particularly preferred process for the preparation of activated graphene comprises:
(a) contacting graphene with an alkaline solution to obtain alkali-treated graphene;
(b) drying and grinding said alkali-treated graphene to obtain ground alkali-treated graphene;
(c) heating said ground alkali-treated graphene in an inert atmosphere to obtain activated graphene;
(d) washing said activated graphene with water and drying; and
(e) optionally heating said activated graphene in an inert atmosphere.

It is believed that the treatment with alkaline solution followed by heating increases the porosity of the graphene and improves its flake-like morphology, e.g. by reducing the thickness of the flakes.

As set out above, it is believed that the presence of graphene in the cathode of the solid-state battery of the present invention improves capacity retention, i.e. the battery is able to achieve or substantially achieve its original capacity for a higher number of cycles. Whilst not wishing to be bound by theory, it is thought that the graphene wraps around the cathode active particles comprising Li ions and allows for some flexibility during the expansion/contraction which occurs during the charge/discharge process. This gives good mechanical stability to the cathode and hence improves the cycle performance. The presence of the graphene on the surface of the cathode active particles also increases the number of contact sites both with the electrolyte and with other cathode active particles. This improves the electrical contact and allows for easy flow of electrons from the current collector to the active material for the Li intercalation reaction, as well as improving electrical interconnectivity of active material, which can increase capacity. Reduced electrical resistance also allows for higher current densities to be used.

The capacity retention is improved most significantly when activated graphene is present in the cathode. Again, whilst not wishing to be bound by theory, this is thought to be due to the improved morphology (i.e. more plate-like form) of the graphene enabling it to more effectively wrap around and conform to the cathode active particles, whilst increasing the number of contact sites, particularly with the electrolyte. It is thought that the increased porosity of the activated graphene may provide more and/or larger pathways for the Li ions to move through the cathode, while still providing the conductive network in the cathode for in-plane electrical conductivity. The mechanical stability of the cathode is also improved by the activated graphene, reducing the detrimental effects of any volume expansion and contraction that occurs during the charge cycling of the cells. This thereby improves the charging performance of the battery.

The cathode present in the solid-state battery of the present invention preferably comprises 0.5 to 20 wt %, more preferably 5 to 17.5 wt % and still more preferably 5 to 15 wt % graphene, preferably activated graphene, based on the total weight of the cathode.

Optionally the cathode present in the solid-state battery of the present invention comprises other conductive agents. Examples of suitable conductive agents include carbon black, graphite, acetylene black, carbon fibers, carbon nanotubes, metal particles and combinations thereof. When present, other conductive agents are preferably present in the cathode in an amount of 0.5 to 15 wt %, more preferably 2.5 to 8 wt % and still more preferably 4 to 6 wt %, based on the total weight of the cathode. Preferably the conductive agents comprise carbon. Such agents may be referred to as carbonaceous additives.

Preferably the cathode present in the solid-state battery of the present invention comprises graphene nanoplatelets and one or more carbonaceous additives, such as carbon black and carbon nanotubes. Advantageously, the combination of graphene nanoplatelets with carbonaceous additives may provide a synergetic effect enhancing the conductivity, performance and stability of the solid-state battery.

Optionally the cathode present in the solid-state battery of the present invention further comprises electrolyte material as an additive(s), preferably traces of electrolyte material. The electrolyte material may be a ceramic electrolyte material, for example, Li_{1.4}Al_{0.4} Ti_{1.6}(PO₄)₃ (LATP).

Preferably the cathode present in the solid-state battery of the present invention comprises graphene, preferably graphene nanoplatelets, one or more carbonaceous additives, such as carbon black and carbon nanotubes, and Li_{1.4}Al_{0.4}Ti_{1.6}(PO₄)₃ (LATP). The combination of graphene with LATP and/or carbonaceous additives may provide a synergetic effect enhancing the stability of the solid-state battery.

The cathode present in the solid-state battery of the present invention preferably comprises a binder. Any conventional binder may be used. Representative examples of suitable binder include polytetrafluoroethylene (PTFE), polyvinylidene fluoride (PVDF), polyethylene (PE), styrene butadiene rubber (SBR), polyethylene oxide (PEO) or combinations thereof. Preferably the binder is polyvinylidene fluoride (PVDF). Optionally the cathode does not comprise a binder.

The cathode present in the solid-state battery of the present invention preferably comprises 2.5 to 20 wt %, more preferably 5 to 17.5 wt % and still more preferably 5 to 15 wt % binder, based on the total weight of the cathode.

Optionally the cathode present in the solid-state battery of the present invention comprises one or more additives. Typical additives that may be present include filler, dispersing agent, stabilizers, ionic liquids (e.g. EMImTFSI) and salts (e.g. AlF₃, LiF) When present, such additives are preferably present in the cathode in an amount of 1-10 wt %, more preferably 2-9 wt % and still more preferably 4-5 wt %, based on the total weight of the cathode.

The cathode present in the solid-state battery of the present invention preferably has a total thickness of 40-1000 microns, more preferably 50-250 microns and still more preferably 150-250 microns.

### Electrolyte

The solid-state electrolyte present in the solid-state battery of the present invention may be any conventional solid electrolyte. It may be an ionic liquid, an inorganic solid electrolyte, solid polymer electrolyte or a composite electrolyte. Preferably the solid electrolyte is a composite electrolyte. A composite electrolyte comprises a polymer matrix and inorganic fillers, preferably inorganic solid electrolytes, therein.

Suitable inorganic solid electrolytes include solid sulfide electrolytes, solid oxide electrolytes, solid nitride electrolytes and solid halide electrolytes. Solid sulfide and solid oxide electrolytes are preferred. Representative examples of suitable solid sulfide electrolytes include LPS halogens (Cl, Br and I), Li₂S—P₂S₅, and Li₂—P₂S₅—LiI. Representative examples of suitable solid oxide electrolytes include NASICON-type oxides, i.e. sodium superionic conductor (e.g. Li_{1.5}Al_{0.5}Ti_{1.5}(PO₄)₃), Li_{1.4}Al_{0.4}Ti_{1.6}(PO₄)₃), garnet-type oxides (e.g. Li₇La₃Zr₂O₁₂) and perovskite-type oxides (e.g. LiLaTiO₃).

Preferably to solid oxide electrolyte include Li_{1.4}Al_{0.4}Ti_{1.6}(PO₄)₃ (LATP).

Suitable solid polymer electrolytes include polyethylene oxide (PEO), polyethylene glycol, polypropylene oxide, polyphosphazene, polysiloxane (e.g. PDMS), polycarbonates, polyesters, polynitriles (e.g. PAN), polyalcohols (PVA), polyamines (e.g. PEI), fluoropolymers (e.g. PVDF, PVDF-HFP), and copolymers thereof.

Suitable composite electrolytes include a polymer selected from polyethylene oxide, polyethylene glycol, polypropylene oxide, polyphosphazene, polysiloxane (e.g. PDMS), polycarbonates, polyesters, polynitriles (e.g. PAN), polyalcohols (PVA), polyamines (e.g. PEI), fluoropolymers (e.g. PVDF, PVDF-HFP), and copolymers thereof, and an inorganic filler. Preferably the inorganic filler is an inorganic solid electrolyte. Particularly preferably the inorganic filler is a solid sulfide electrolyte, solid oxide electrolyte, solid nitride electrolyte or solid halide electrolyte and still more preferably a solid sulfide electrolyte or a solid oxide electrolyte. Representative examples of suitable solid sulfide electrolytes include LPS halogens (Cl, Br and I), Li₂S—P₂S₅, and Li₂—P₂S₅—LiI. Representative examples of suitable solid oxide electrolytes include NASICON-type oxides, i.e. sodium superionic conductor (e.g. Li_{1.5}Al_{0.5}Ti_{1.5}(PO₄)₃), Li_{1.4}Al_{0.4}Ti_{1.6}(PO₄)₃), garnet-type oxides (e.g. Li₇La₃Zr₂O₁₂) and perovskite-type oxides (e.g. LiLaTiO₃). One particularly preferred composite electrolyte is PVDF and Li_{1.4}Al_{0.4}Ti_{1.6}(PO₄)₃.

The composite electrolyte preferably present in the solid-state battery of the present invention preferably comprises 5-30 wt %, and more preferably 10-25 wt % polymer, based on the total weight of the electrolyte. Correspondingly, the composite electrolyte preferably present in the solid-state battery of the present invention preferably comprises 70-95 wt %, and more preferably 75-90 wt % inorganic solid electrolyte, based on the total weight of the electrolyte.

Preferably the solid electrolyte is pre-soaked in one or more lithium salts. This is a well known process, and any lithium salt conventionally used for this purpose may be employed. Suitable lithium salts include lithium perchlorate (LiClO₄), lithium triflate (LiCF₃SO₃), lithium hexafluorophosphate (LiPF₆), lithium tetrafluoroborate (LiPF₆), lithium trifluoromethanesulfonyl imide (LiN(CF₃SO₂)₂) or mixtures thereof.

Optionally the electrolyte present in the solid-state battery of the present invention comprises one or more additives. Typical additives that may be present include dispersing agent, stabilizers, ionic liquids (e.g. EMImTFSI) and salts (e.g. AlF₃, LiF). When present, such additives are preferably present in the electrolyte in an amount of 0-5 wt %, more preferably 0.5-3 wt % and still more preferably 1-1.5 wt %, based on the total weight of the electrolyte. Preferably, however, the electrolyte does not comprise any additives.

The electrolyte present in the solid-state battery of the present invention preferably has a total thickness of 10-500 microns, more preferably 25-250 microns and still more preferably 50-250 microns.

### Anode

The anode present in the solid-state battery of the present invention preferably comprises an anode current collector. Any material conventionally used for this purpose may be employed. For example, the anode current collector may be a sheet, foil, foam or mesh comprising a conductive metal, e.g. aluminium (AI), copper (Cu), titanium (Ti), germanium (Ge), stainless steel or mixtures thereof. Preferably the anode current collector is aluminium. Preferably lithium is electrodeposited onto the anode current collector during cycling. Advantageously, this reduces dendrite formation and improves battery stability, e.g. compared to the use of a lithium metal anode.

Preferably, the anode present in the solid-state battery of the present invention may comprise (e.g. consist of) lithium metal (e.g. lithium foil).

The anode present in the solid-state battery of the present invention optionally comprises an anode active material. When present, the anode active material is preferably present as a layer in between the electrolyte and the anode current collector. Examples of suitable anode active material include carbon materials such as natural graphite and spherical graphite, silicon materials such as amorphous silica, lithium titanium oxides such as Li₄Ti₅O₁₂ and metal lithium. Carbon materials are particularly preferred.

Optionally the anode further comprises conductive agent. Examples of suitable conductive agents include carbon black, graphite, acetylene black, carbon fibers, carbon nanotubes, metal particles and combinations thereof.

Optionally the anode comprises binder. Examples of suitable include polytetrafluoroethylene (PTFE), polyvinylidene fluoride (PVDF), polyethylene (PE), styrene butadiene rubber (SBR), or combinations thereof. Preferably the binder is polyvinylidene fluoride (PVDF).

The anode present in the solid-state battery of the present invention preferably has a total thickness of 20-150 microns, more preferably 25-100 microns and still more preferably 35-50 microns.

### Preparation

The solid-state battery of the present invention may be prepared by conventional methodology, well established in the field of solid-state lithium batteries. The method comprises:
(i) preparing a cathode comprising a cathode active material comprising Li ions, graphene and optionally binder;
(ii) preparing an electrolyte;
(v) preparing an anode; and
(vi) laminating said cathode, electrolyte and anode to form said solid-state battery.

Preferably the solid-state battery of the present invention is prepared by separately preparing the cathode and the anode. Preferably the electrolyte is formed on a surface of the cathode to form a cathode/electrolyte structure. Preferably the anode is laminated to a cathode/electrolyte structure.

For preparation of the cathode, the binder (when present), cathode active material comprising Li ions, and graphene are preferably mixed in a solvent to form a slurry, then applied to a current collector, and dried. Preferably the binder (when present) and solvent are premixed with the graphene, prior to addition of the cathode active material comprising Li ions.

For preparation of the anode, the anode active material (when present) and any optional ingredients are mixed in a solvent to form a slurry, then applied to a current collector, and dried.

For preparation of the electrolyte, the ingredients are mixed with solvent to form a slurry. The electrolyte slurry is then applied to the cathode (or anode) active material layer, and dried.

Any mixing means may be employed, e.g. sonication, vacuum mixing etc. Any application means may be applied, e.g. doctor blade, etc.

Subsequently, the cathode/solid electrolyte (or anode/solid electrolyte) is preferably laminated with the anode (or cathode) to form the solid-state battery. Optionally the stacked cathode structure may be pressurised. Preferably the solid-state battery of the present invention has a thickness of 70-750 microns, more preferably 100-600 microns and still more preferably 235-550 microns. Preferably a tab is attached is each of the cathode collector and the anode collector. Preferably the solid-state battery is packaged in housing, preferably a pouch cell.

### Pouch Cell and Preparation Method Therefor

Preferably the pouch cell comprises an solid-state battery as hereinbefore defined, and a packaging material defining a pouch which encloses the cathode, electrolyte, and anode. The pouch may be made of any material conventional in the art, e.g. laminated aluminium foil or the like.

Preferred pouch cells are multi-layered. Preferred pouch cells comprise a plurality of cathodes, electrolyte and anodes. Preferred pouch cells comprise 2 to 20, more preferably 5 to 15 and still more preferably 6 to 12 cathodes. Preferred pouch cells comprise 2 to 20, more preferably 5 to 15 and still more preferably 6 to 12 anodes. Preferred pouch cells comprise 4 to 40, more preferably 10 to 30 and still more preferably 12 to 24 electrolytes.

Preferably each cathode or cathode current collector has a protruding tab that extends external to the pouch. Preferably the protruding tabs on the cathode/cathode current collectors are all aligned. Preferably each anode or anode current collector has a protruding tab that extends external to the pouch. Preferably the protruding tabs on the anode/anode current collector are aligned. Optionally each set of protruding tabs may be adhered together to provide a single, thicker protruding tab for each of the plurality of cathodes and anodes. Electrical connections are made to the protruding tabs.

A pouch cell has a total weight based on the weights of the anode(s), cathode(s), electrolyte, and packaging material. It is desirable to minimize weight due to elements that do not directly contribute to the functioning of the battery, e.g., weight contributed by the current collectors, inactive materials such as binders and additives, and packaging material.

Pouch cells are conventionally prepared in a variety of shapes and sizes. Preferably the pouch cell is rectangular. Preferably the pouch cell has dimensions of 30-250 mm by 30-250 mm, more preferably 40-200 mm by 40-200 mm and still more preferably 40-60 by 40-60 mm. Optionally the pouch cell has a surface area of 1200-62,500 mm², and more preferably 1600-6400 m².

The present invention also relates to a method of making a pouch cell as hereinbefore defined, comprising:
(i) making a battery as hereinbefore defined; and
(ii) enclosing the battery in packaging defining a pouch.

### Performance

Preferably the solid-state battery, preferably in the form of a pouch cell, achieves a capacity retention of at least 50%, more preferably at least 60% and still more preferably at least 70%, after 40 cycles, e.g. as tested according to the procedure set out in the examples herein.

Preferably the solid-state battery, preferably in the form of a pouch cell, achieves a capacity retention of at least 50%, more preferably at least 60% and still more preferably at least 70%, after 80 cycles, e.g. as tested according to the procedure set out in the examples herein.

Preferably the solid-state battery, preferably in the form of a pouch cell, achieves a capacity retention of at least 50%, more preferably at least 60% and still more preferably at least 70%, after 100 cycles, e.g. as tested according to the procedure set out in the examples herein.

Preferably the solid-state battery, preferably in the form of a pouch cell, operates at a C rate of 0.1 C to 3C. The C-rate is the unit used to measure the speed at which a battery is fully charged or discharged. For example, charging at a C-rate of 1C means that the battery is charged from 0-100% in one hour. A C-rate higher than 1C means a faster charge; for example, a 3C rate is three times faster, so a full charge in 20 minutes.

### Devices

The present invention also relates to a device comprising a solid-state battery, preferably in the form of a pouch cell, as hereinbefore defined. Pouch cells are attractive because they make efficient use of space, e.g. they can achieve 90 to 95% packing efficiency, which is high compared to other battery types (e.g. cylindrical cells). Pouch cells also have the advantages of flexibility of size and shape, and are generally more lightweight than other battery types, due to elimination of metal casing.

Examples of devices that comprising an solid-state battery of the present invention, preferably in the form of a pouch cell, include electric vehicles, portable electronic equipment (e.g. mobile phones, tablets), robotics, aerospace devices and stationary energy storage.

### Solid-State Cathode Composition and Preparation Method Therefor

The present invention also relates to a solid-state cathode composition comprising:
(i) a cathode comprising cathode active material comprising Li ions;
(ii) activated graphene; and
(iii) optionally binder

Preferably the cathode active material comprising Li ions is as set out above in relation to the cathode of the solid-state battery. Preferably the activated graphene is as set out above in relation to the cathode of the solid-state battery. Preferably the solid-state cathode composition comprises a binder. Preferably the binder is as set out above in relation to the cathode of the solid-state battery.

Preferably the solid-state cathode composition comprises 60-95 wt %, more preferably 65-90 wt % and still more preferably 70-90 wt % cathode active material, based on the total weight of the composition.

Preferably the solid-state cathode composition comprises 2.5 to 20 wt %, more preferably 5 to 17.5 wt % and still more preferably 5 to 15 wt % activated graphene, based on the total weight of the composition.

Preferably the solid-state cathode composition comprises 2.5 to 20 wt %, more preferably 5 to 17.5 wt % and still more preferably 5 to 15 wt % binder, based on the total weight of the composition.

The present invention also relates to a method of making a solid-state cathode composition comprising mixing cathode active material comprising Li ions, activated graphene, and optionally binder. Any conventional mixing means may be employed.

The present invention also relates to a solid-state cathode comprising a composition as hereinbefore defined.

The present invention also relates to a method of making a solid-state cathode as hereinbefore defined comprising depositing a slurry of a solid-state cathode composition on a cathode current collector, and drying to form said cathode.

Finally the present invention also relates to use of a composition as hereinbefore defined to make a solid-state cathode or a solid-state battery.

The invention will now be described with reference to the following non-limiting Figures and examples, wherein:

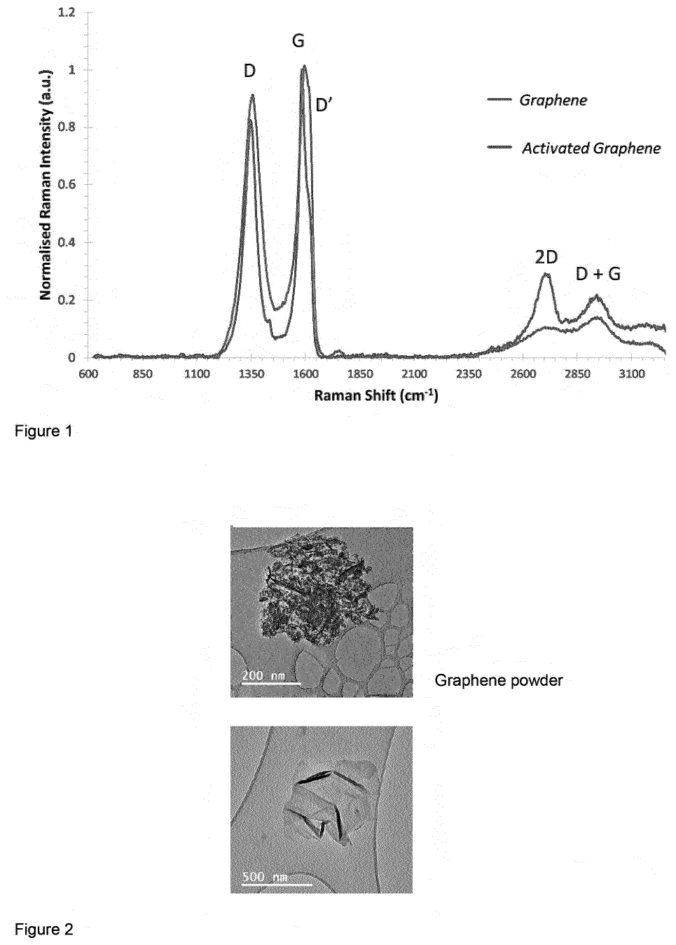

FIG. 1 is Raman spectra of powdered graphene and activated graphene;

FIG. 2 is TEM images of powdered graphene and activated graphene; and

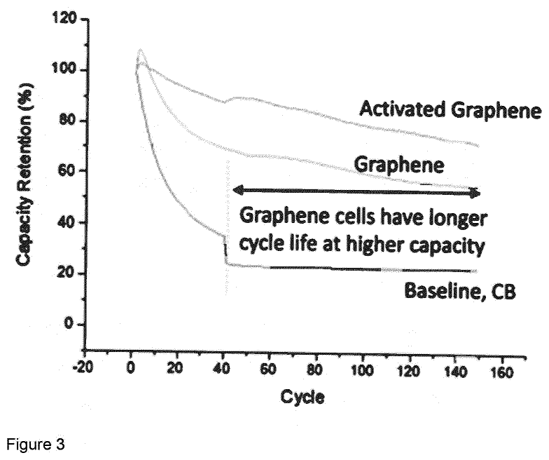

FIG. 3 is a graph of capacity retention vs. cycle for solid-state batteries of the invention versus a conventional solid-state battery comprising a cathode comprising carbon black.

### EXAMPLES

### Materials

Graphene powder was obtained commercially. It had an average particle size of <0.5 micron.

Polyvinylidene (PVDF) binder, N-methyl-2-pyrrolidone (NMP), LiNi_{0.6}Mn_{0.2}Co_{0.2}O₂ (NMC622), Li_{1.4}Al_{0.4}Ti_{1.6}(PO₄)₃ (LATP), LiPF₆ and aluminium foil were all obtained commercially.

### Test Methods

Raman spectroscopy was carried out using a Renishaw inVia instrument, with 532 nm laser excitation.

TEM was carried out using a Tecnai 20, using an accelerating voltage of 200 kV.

Specific surface area was determined by BET Nitrogen absorption using a Quadrasorb EVO FVD-3 Surface area and Pore size analyser

Cyclic charge/discharge testing was carried out by continuously charging/discharging the pouch cells at a rate 1C for up to 150 cycles.

### Preparation of Activated Graphene

2 g of graphene powder was mixed into 100 mL of aqueous 7M KOH and stirred for 3 hours at 200 rpm, then left sitting overnight for at least 18 hours. The graphene/KOH dispersion was filtered using filter paper (0.2 um pore size) to remove excess KOH solution. The filtered powder was dried in an oven at 65° C. for at least 18 hours. Once dried, the powder was ground manually with a mortar and pestle for 5 minutes then placed into a tubular furnace with argon flow at a rate of 150 sccm, and temperature of 800° C. (10° C./min heating ramp rate). The sample was heated for 1 hour, and once completed, cooled down under argon flow. The powder was then removed and washed thoroughly with DI water, and filtered until a pH value of 7 was reached. The activated-graphene powder (a-GP) was heated in an oven at 65° C. for at least 18 hours then placed in a tubular furnace with argon flow rate of 150 sccm, and temperature of 800° C. (10 C/min). The sample was heated for 1 hour, and once completed, cooled down under argon flow. The average particle size of the activated graphene was <2 micron.

### Comparison of Graphene and Activated Graphene

The graphene powder and activated-graphene powder were analysed by TEM and Raman spectroscopy.

The Raman spectra are shown in FIG. 1. The I_{D}/I_{G} intensity ratio increases after activation is carried out (graphene: 0.83, activated graphene: 0.90), which indicates the successful introduction of pores into the graphene structure. Furthermore, the D′ peak intensity is significantly increased for the activated graphene, approximately doubling in height. The intensity of the D′ peak is known to be proportional to the presence of vacancy defects within graphene, and therefore provides further evidence that the porosity of the activated graphene is increased compared to the graphene starting material.

The TEM images are shown in FIG. 2. The activated-graphene powder has a cleaner, and thinner morphology. It is more flake-like, i.e. it has a platelet structure.

The specific surface area (using BET Nitrogen adsorption) of graphene powder and activated-graphene powder was also determined. These were 740m²/g and 613.12 m²/g respectively. The activation step therefore decreases the specific surface area of the graphene powder.

### Preparation of Cathode Composition and Cathode

Polyvinylidene (PVDF) binder was dissolved by stirring it in N-methyl-2-pyrrolidone (NMP) (NMP amount is 150% of solid material), and heated to 80° C. for about an hour. The graphene (either powdered graphene or activated-graphene powder) was then stirred into the PVDF containing NMP solution. The mixture of NMP+PVDF+graphene was bath sonicated for 20 mins to 1 hour. Then, NMC was added and the mixture placed into a vacuum mixer for 20 mins (or until the material was fully dispersed). Extra NMP was added to reduce the viscosity if required. The target viscosity was 5000 cP. The resulting slurry mixture was doctor blade-coated onto the current collector (carbon coated aluminium) and dried in a vacuum oven at 80° C. for 12 hours to form the cathode. The cathode had a wet film thickness of 200 μm.

### Preparation of a Pouch Cell

The solid electrolyte used was Li_{1.4}Al_{0.4}Ti_{1.6}(PO₄)₃ (LATP) mixed with PVDF. PVDF was dissolved by stirring in NMP (NMP amount is 120% of solid material) and heated to 80° C. LATP was added and stirred into the NMP+PVDF solution, which was then placed into the vacuum mixer for 20 mins (or until the material was fully dispersed). The slurry was then coated onto glass and dried in a vacuum oven at 80° C. for 12 hours. Once dry the LATP film was removed from the glass and cut into the correct dimensions for a pouch cell then soaked in battery electrolyte, 1M LiPF₆ (EC/DMC) for 12 hours. The wet film thickness of the solid electrolyte was 100 μm.

The solid electrolyte was stacked on top of the cathode. Then the current collector for the anode (Aluminium foil) was placed on top of the stack. This stack was then inserted into a polymer-laminated Aluminium pouch cell, which was vacuum heat sealed at 180° C. The dimensions of the pouch cell were 50 mm×40 mm.

### Cyclic Charge/Discharge Testing

Three different cathode compositions with different carbon sources (carbon black, graphene and activated graphene) were assembled into pouch cells as described in the preparation methods above. The pouch cells with the cathode containing carbon black serves as a baseline cell. The three pouch cells were continuously charged/discharged at a rate 1C for up to 150 cycles, and the capacity is measured over the test duration. The results are shown in FIG. 3.

The baseline cell with the cathode containing carbon black can be seen to reduce in capacity during the first 40 cycles to ˜30% of its original capacity value. The cathode containing activated graphene reduces to ˜80% capacity after 150 cycles, while the powdered graphene reduces to around 60% after 150 cycles.

This experiment shows that pouch cells with graphene-containing cathodes are able to operate at higher capacity for much longer than the corresponding pouch cells with carbon black containing cathodes, and hence can be expected to have a longer operating life.

In addition, for a solid-state battery, a C rate of 1 is relatively high, compared to many literature reports that quote values of 0.05C. This improvement may be caused by the higher conductivity of the graphene and the superior mechanical stability achieved allowing any volume expansion and contraction to be overcome during the cycling.

1. A solid-state battery, preferably a pouch cell, comprising:
(i) a cathode comprising cathode active material comprising Li ions, graphene, and optionally binder;
(ii) an electrolyte; and
(iii) an anode, preferably a lithium anode,
wherein said electrolyte is positioned in between said cathode and said anode.

2. The battery as claimed in claim 1, wherein said cathode comprises cathode active material comprising Li ions selected from lithium cobalt oxide, lithium nickel oxide, lithium iron phosphate, lithium manganese oxide, lithium copper oxide, lithium vanadium oxide, lithium nickel composite oxide, lithium nickel cobalt aluminium oxide, lithium nickel manganese oxide, lithium manganese composite oxide and Ni—Co—Mn ternary lithium metal oxide.

3. The A-battery as claimed in claim 2, wherein said cathode active material comprising Li ions is Ni—Co—Mn ternary lithium metal oxide (Li[NiₓCo₁₋₂ₓMnₓO]₂ wherein x is >0 and <0.5, NMC).

4. The battery as claimed in claim 1, wherein said cathode comprises graphene in the form of platelets, preferably nanoplatelets.

5. The battery as claimed in claim 4, wherein said cathode comprises graphene in the form of nanoplatelets and the cathode further comprises a carbonaceous additive, preferably carbon black and/or carbon nanotubes.

6. The battery as claimed in claim 1, wherein said cathode comprises graphene which is activated graphene.

7. The battery as claimed in claim 6, wherein said activated graphene has an average particle size of 0.1-2 microns, and more preferably 0.1 to 1 micron.

8. The battery as claimed in claim 1, wherein said cathode comprises binder.

9. The battery as claimed in claim 1, wherein said electrolyte comprises ionic liquid, inorganic solid electrolyte, solid polymer electrolyte or a composite electrolyte, preferably a composite electrolyte.

10. The battery as claimed in claim 1, wherein said anode comprises an anode current collector.

11. The battery as claimed in claim 1, wherein said anode comprises (e.g. consists of) lithium metal.

12. The battery as claimed in claim 11, wherein said lithium is electrodeposited onto the anode current collector during cycling.

13. The battery as claimed in claim 1, wherein said cathode further comprises Li_{1.4}Al_{0.4}Ti_{1.6}(PO₄)₃ (LATP), preferably traces of LATP, and/or one or more carbonaceous additives, preferably carbon black and/or carbon nanotubes.

14. A method of making a battery as claimed in claim 1, comprising:
(i) preparing a cathode comprising a cathode active material comprising Li ions, graphene and optionally binder;
(ii) preparing an electrolyte;
(iii) preparing an anode; and
(iv) laminating said cathode, electrolyte and anode to form said solid-state battery.

15. (canceled)

16. (canceled)

17. A device, e.g. an electric vehicle, comprising a solid-state battery, preferably a pouch cell, as claimed in claim 1.

18. A solid-state cathode composition comprising:
(i) a cathode comprising cathode active material comprising Li ions;
(ii) activated graphene; and
(iii) optionally binder

19. A method of making a solid-state composition as claimed in claim 18 comprising: mixing cathode active material comprising Li ions; activated graphene; and, when present, binder.

20. A solid-state cathode comprising a composition as claimed in claim 18.

21. (canceled)

22. (canceled)
